(19) United States
(12) Patent Application Publication
(10) Pub. No.: US 2019/0196223 A1
(43) Pub. Date: Jun. 27, 2019

(54) DEVICE AND METHOD FOR DESIGNING OPHTHALMIC LENS

(71) Applicant: HON HAI PRECISION INDUSTRY CO., LTD., New Taipei (TW)

(72) Inventor: WEN-KAI LI, New Taipei (TW)

(21) Appl. No.: 15/859,760

(22) Filed: Jan. 2, 2018

(30) Foreign Application Priority Data
Dec. 27, 2017 (TW) 106146100

(51) Int. Cl. G02C 7/02; G06F 17/13; G05B 19/4097

(52) U.S. Cl. CPC G02C 7/028; G05B 2219/35081; G05B 19/4097; G06F 17/13

(57) ABSTRACT

A device and method for designing an ophthalmic lens includes a design of shape according to a Zernike polynomial, and calculating a curvature of each point of the target surface shape to obtain a curvature distribution overall. A diopter distribution over the target surface shape corresponding to the obtained curvature distribution is calculated, and the calculated diopter distribution is matched against a preset diopter distribution. If matching, a processing machine is controlled to manufacture the ophthalmic lens according to the Zernike polynomial. If not matching, the Zernike polynomial is modified, until the actual surface shape as measured is sufficiently close to the target surface shape.

### FIELD

The subject matter relates to a device and a method for designing an ophthalmic lens.

### BACKGROUND

Ophthalmic lenses are commonly worn by users to correct vision, or for cosmetic or therapeutic reasons. After a surface shape of the ophthalmic lens is designed, the ophthalmic lens is manufactured by precise machining or injection molding. The actual ophthalmic lens may shrink compared to the designed lens, so that the actual ophthalmic lens cannot meet the requirement of the user. A one-station service for designing and testing the ophthalmic lens is required.

### BRIEF DESCRIPTION OF THE DRAWINGS

Implementations of the present technology will now be described, by way of example only, with reference to the attached figures.

FIG. 1 is a block diagram of an exemplary embodiment of a device for designing an ophthalmic lens.

FIG. 2 is a flowchart of an exemplary embodiment of a method for designing an ophthalmic lens.

FIG. 3 is a diagram of a progressive addition lens made in the method of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

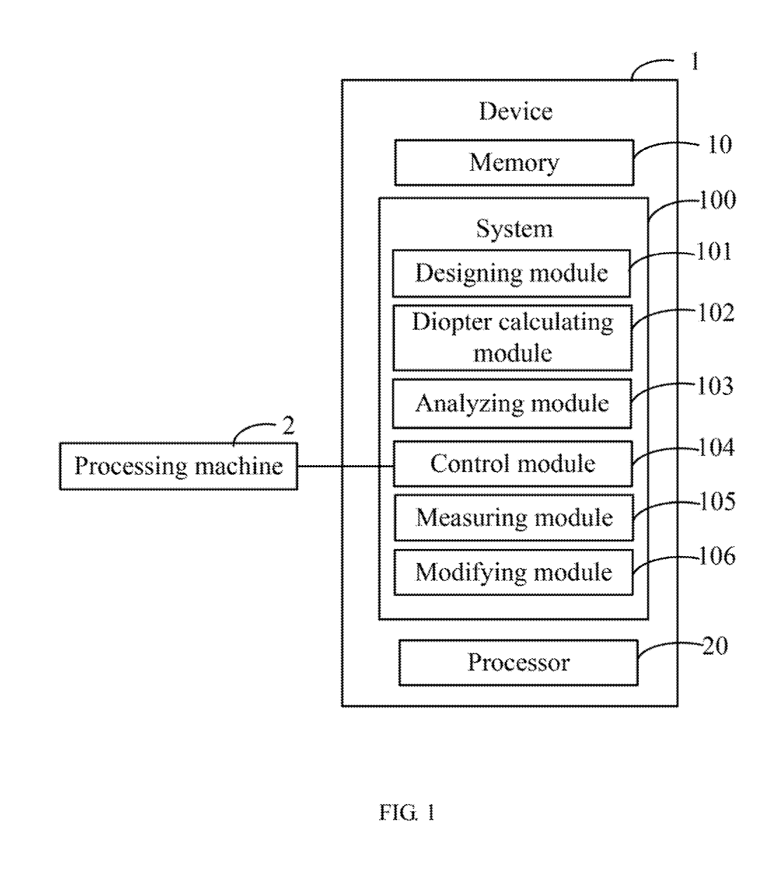

FIG. 1 illustrates an exemplary embodiment of a device 1 for designing an ophthalmic lens. The device 1 comprises a memory 10 and at least one processor 20. The memory 10 stores a system 100 for designing a particular surface shape (target surface form) for the ophthalmic lens. The memory 10 can be an internal storage system of the device 1 such as a flash memory, a random access memory (RAM) for temporary storage of information, and/or a read-only memory (ROM) for permanent storage of information. The memory 10 can also be an external storage system, such as a hard disk, a storage card, or a data storage medium. The ophthalmic lens can be an eyeglass, a contact lens, or an intraocular lens. More specifically, the ophthalmic lens can be a progressive addition lens.

The system 100 comprises a number of modules, which are a collection of software instructions which can be executed by the processor 20 to perform the functions of the system 100. The processor 20 can be a central processing unit (CPU), a microprocessor, or other data processor chip that performs functions of the system 100.

The system 100 comprises a designing module 101, a diopter calculating module 102, an analyzing module 103, a control module 104, a measuring module 105, and a modifying module 106.

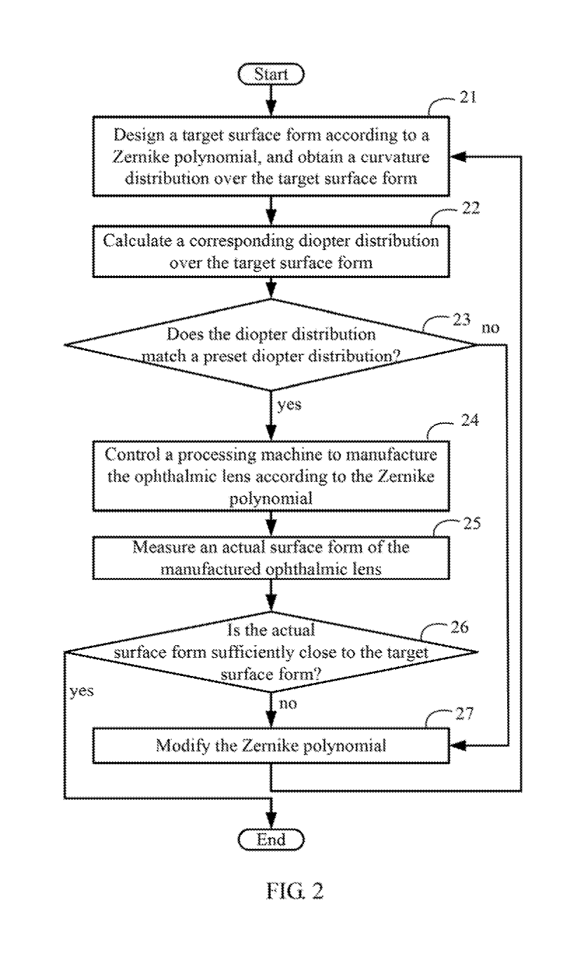

FIG. 2 illustrates an exemplary embodiment of a method for designing an ophthalmic lens. The method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 21.

At block 21, the designing module 101 designs a target surface form of the ophthalmic lens according to a Zernike polynomial, and calculates a curvature of each point of the target surface form to obtain a curvature distribution over the target surface form.

Table 1 shows a sequence of polynomials and Zernike coefficients of the Zernike polynomial. Wherein, ρ and θ represent two variables of the polynomials, which are orthogonal on the unit disk. Each polynomial can be multiplied by the corresponding Zernike coefficient to obtain the target surface form.

TABLE 1

| [symbol] | polynomials |
|---|---|
| Z0 | 1 |
| Z1 | ρcosθ |
| Z2 | ρsinθ |
| Z3 | 2ρ² − 1 |
| Z4 | ρ²cos2θ |
| Z5 | ρ²sin2θ |
| Z6 | (3ρ² − 2)ρcosθ |
| Z7 | (3ρ² − 2)ρsinθ |
| Z8 | 6ρ⁴ − 6ρ² + 1 |
| Z9 | ρ³cos3θ |
| Z10 | ρ³sin3θ |
| Z11 | (4ρ² − 3)ρ²cos2θ |
| Z12 | (4ρ² − 3)ρ²sin2θ |
| Z13 | (10ρ⁴ − 12ρ² + 3)ρcosθ |
| Z14 | (10ρ⁴ − 12ρ² + 3)ρsinθ |
| Z15 | 20ρ⁶ − 30ρ⁴ + 12ρ² − 1 |
| Z16 | ρ⁴cos4θ |
| Z17 | ρ⁴sin4θ |
| Z18 | (5ρ² − 4)ρ³cos3θ |
| Z19 | (5ρ² − 4)ρ³sinθ |
| Z20 | (15ρ⁴ − 20ρ² + 6)ρ²cos2θ |
| Z21 | (15ρ⁴ − 20ρ² + 6)ρ²sin2θ |
| Z22 | (35ρ⁶ − 60ρ⁴ + 30ρ² − 4)ρcosθ |
| Z23 | (35ρ⁶ − 60ρ⁴ + 30ρ² − 4)ρsinθ |
| Z24 | 70ρ⁸ − 140ρ⁶ + 90ρ⁴ − 20ρ² + 1 |

That is, the target surface form can be described by a function Z(ρ,θ). The obtained curvature distribution of the target surface form can be described by function f(x,y). Wherein, x=ρ cos θ, y=ρ sin θ.

At block 22, the diopter calculating module 102 calculates a diopter distribution over the target surface form corresponding to the obtained curvature distribution.

In at least one exemplary embodiment, the calculated diopter distribution can be described as function H(x,y):

H=[(1+f_{y}²)×fₓₓ−2×fₓ×f_{y}×f_{xy}+(1+fₓ²)×f_{yy}]/[2×(1+fₓ²+f_{y}²)^{1.5}]

Wherein, f(x,y) denotes the obtained curvature distribution of the target surface form, fₓ denotes differentiating the obtained curvature distribution f(x,y) with respect to x, f_{y} represents differentiating the obtained curvature distribution f(x,y) with respect to y, fₓₓ represents differentiating the obtained curvature distribution f(x,y) with respect to x twice, f_{yy} represents differentiating the obtained curvature distribution f(x,y) with respect to y twice, and f_{xy} represents differentiating the obtained curvature distribution f(x,y) with respect to x and then y.

At block 23, the analyzing module 103 determines whether the calculated diopter distribution matches a preset diopter distribution; if yes, the procedure goes to block 24, otherwise, the procedure goes to block 27.

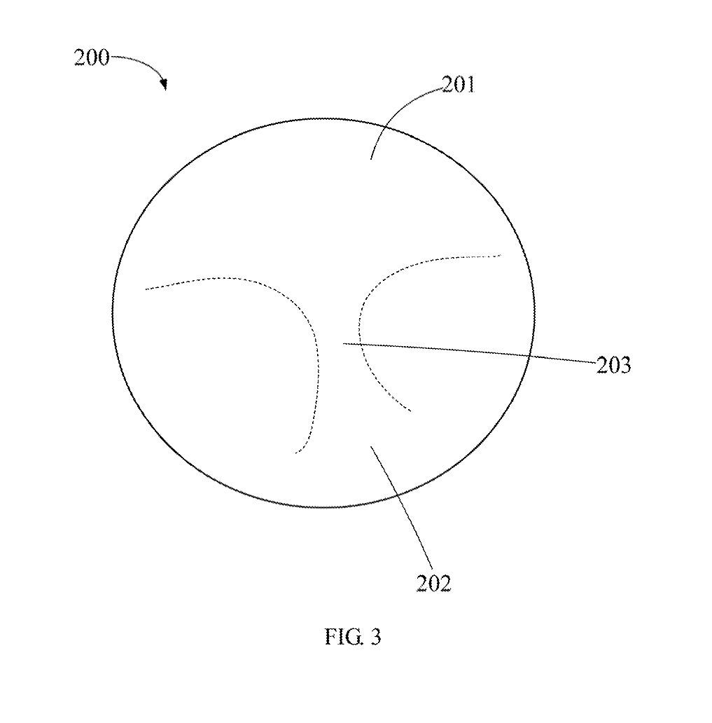

Referring to FIG. 3, in at least one exemplary embodiment, the ophthalmic lens is a progressive addition lens 200 that comprises a distant region 201, a near region 202, and an intermediate region 203 between the distant region 201 and the near region 202. The preset diopter distribution is the dioptric gradually and continuously increasing from the distant region 201 to the intermediate region 203 and the near region 202, to obtain a desired diopter at the near region 202.

At block 24, the control module 104 controls a processing machine 2 to manufacture the ophthalmic lens according to the Zernike polynomial.

In at least one exemplary embodiment, the processing machine 2 can be a computer numerical control machine or an injection molding machine. The control module 104 outputs the Zernike polynomial to the processing machine 2, thereby controlling the processing machine 2 to manufacture the ophthalmic lens by precise machining or injection molding.

At block 25, the measuring module 105 measures an actual surface form of the manufactured ophthalmic lens.

At block 26, the analyzing module 103 determines whether the measured actual surface form is sufficiently close to the target surface form. If no, the procedure goes to block 27, otherwise, the procedure ends.

In at least one exemplary embodiment, the analyzing module 103 calculates a difference between the measured actual surface form and the target surface form, and determines whether the calculated difference is less than or equal to a preset value. If the calculated difference is less than or equal to the preset value, the analyzing module 103 determines that the measured actual surface form is sufficiently close to the target surface form. If the calculated difference is greater than the preset value, the analyzing module 103 determines that the measured actual surface form is not sufficiently close to the target surface form. The preset value can be varied according to need. For example, the preset value can be zero.

At block 27, the modifying module 106 modifies the Zernike polynomial. Then, the block 21 is repeated (here, the target surface form is designed according to the modified Zernike polynomial) until the measured actual surface form is sufficiently close to the target surface form.

The device and method provides one-station service for designing and testing the ophthalmic lens. For the ophthalmic lens which at first does not meet the requirement, the device and method can modify the ophthalmic lens until the final ophthalmic lens is sufficiently close to the target ophthalmic lens.

Even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A device for designing an ophthalmic lens, comprising:
at least one processor; and
a memory coupled to the at least one processor and storing one or more programs, wherein when executed by the at least one processor, the one or more programs causing the at least one processor to:
design a target surface form of the ophthalmic lens according to a Zernike polynomial, and calculate a curvature of each point of the target surface form to obtain a curvature distribution over the target surface form;
calculate a diopter distribution over the target surface form corresponding to the obtained curvature distribution, and determining whether the calculated diopter distribution matches a preset diopter distribution;
control a processing machine to manufacture the ophthalmic lens according to the Zernike polynomial when the calculated diopter distribution matches the preset diopter distribution;
measure an actual surface form of the manufactured ophthalmic lens, and determine whether the measured actual surface form is sufficiently close to the target surface form; and
modify the Zernike polynomial when the measured actual surface form is not sufficiently close to the target surface form, until the measured actual surface form is sufficiently close to the target surface form.

2. The device of claim 1, wherein the calculated diopter distribution is described as a function H(x,y):
H=[(1+f_{y}²)×fₓₓ−2×fₓ×f_{y}×f_{xy}+(1+fₓ²)×f_{yy}]/[2×(1+fₓ²+f_{y}²)^{1.5}]
wherein, f(x,y) denotes the obtained curvature distribution of the target surface form, fₓ denotes differentiating the obtained curvature distribution f(x,y) with respect to x, f_{y} represents differentiating the obtained curvature distribution f(x,y) with respect to y, fₓₓ represents differentiating the obtained curvature distribution f(x,y) with respect to x twice, f_{yy} represents differentiating the obtained curvature distribution f(x,y) with respect to y twice, and f_{xy} represents differentiating the obtained curvature distribution f(x,y) with respect to x and then y.

3. The device of claim 1, wherein the ophthalmic lens is a progressive addition lens that comprises a distant region, a near region, and an intermediate region between the distant region and the near region, the preset diopter distribution is a dioptric gradually and continuously increasing from the distant region to the intermediate region and the near region, to obtain a desired diopter at the near region.

4. The device of claim 1, wherein the one or more programs cause the at least one processor to:
calculate a difference between the measured actual surface form and the target surface form;
determine whether the calculated difference is less than or equal to a preset value; and
determine that the measured actual surface form is sufficiently close to the target surface form when the calculated difference is less than or equal to the preset value, and that the measured actual surface form is not sufficiently close to the target surface form when the calculated difference is greater than the preset value.

5. The device of claim 1, wherein the one or more programs cause the at least one processor to output the Zernike polynomial to the processing machine, thereby controlling the processing machine to manufacture the ophthalmic lens by precise machining or injection molding.

6. A method for designing an ophthalmic lens, comprising:
designing a target surface form of the ophthalmic lens according to a Zernike polynomial, and calculating a curvature of each point of the target surface form to obtain a curvature distribution over the target surface form;
calculating a diopter distribution over the target surface form corresponding to the obtained curvature distribution, and determining whether the calculated diopter distribution matches a preset diopter distribution;
controlling a processing machine to manufacture the ophthalmic lens according to the Zernike polynomial when the calculated diopter distribution matches the preset diopter distribution;
measuring an actual surface form of the manufactured ophthalmic lens, and determining whether the measured actual surface form is sufficiently close to the target surface form; and
modifying the Zernike polynomial when the measured actual surface form is not sufficiently close to the target surface form, until the measured actual surface form is sufficiently close to the target surface form.

7. The method of claim 6, wherein the calculated diopter distribution is described as a function H(x,y):
H=[(1+f_{y}²)×fₓₓ−2×fₓ×f_{y}×f_{xy}+(1+fₓ²)×f_{yy}]/[2×(1+fₓ²+f_{y}²)^{1.5}]
wherein, f(x,y) denotes the obtained curvature distribution of the target surface form, fₓ denotes differentiating the obtained curvature distribution f(x,y) with respect to x, f_{y} represents differentiating the obtained curvature distribution f(x,y) with respect to y, fₓₓ represents differentiating the obtained curvature distribution f(x,y) with respect to x twice, f_{yy} represents differentiating the obtained curvature distribution f(x,y) with respect to y twice, and f_{xy} represents differentiating the obtained curvature distribution f(x,y) with respect to x and then y.

8. The method of claim 6, wherein the ophthalmic lens is a progressive addition lens that comprises a distant region, a near region, and an intermediate region between the distant region and the near region, the preset diopter distribution is a dioptric gradually and continuously increasing from the distant region to the intermediate region and the near region, to obtain a desired diopter at the near region.

9. The method of claim 6, wherein determining whether the measured actual surface form is sufficiently close to the target surface form further comprises:
calculating a difference between the measured actual surface form and the target surface form;
determining whether the calculated difference is less than or equal to a preset value; and
determining that the measured actual surface form is sufficiently close to the target surface form when the calculated difference is less than or equal to the preset value, and determining that the measured actual surface form is not sufficiently close to the target surface form when the calculated difference is greater than the preset value.

10. The method of claim 6, wherein controlling a processing machine to manufacture the ophthalmic lens according to the Zernike polynomial further comprises:
outputting the Zernike polynomial to the processing machine, thereby controlling the processing machine to manufacture the ophthalmic lens by precise machining or injection molding.
